(19) United States
(12) Patent Application Publication
(10) Pub. No.: US 2018/0148171 A1
(43) Pub. Date: May 31, 2018

(54) CONSTRUCTION GROUP FOR AN AIRCRAFT FOR FEEDING A LINE TO A CABIN MODULE

(71) Applicant: Airbus Operations GmbH, Hamburg (DE)

(72) Inventors: Sebastian Scheffler, Hamburg (DE); Anja Wessels, Hamburg (DE); Malte Fuerstenberg, Hamburg (DE); Benjamin Klotz, Hamburg (DE); Olaf Glaesker, Hamburg (DE); Zoltan Czudar, Hamburg (DE); Ines Dittmann, Hamburg (DE); Bernd Kazmeier, Hamburg (DE)

(73) Assignee: Airbus Operations GmbH, Hamburg (DE)

(21) Appl. No.: 15/812,080

(22) Filed: Nov. 14, 2017

(30) Foreign Application Priority Data
Nov. 29, 2016 (DE) 102016122986.5

(51) Int. Cl. B64D 11/00; B64D 11/04; B64D 11/02

(52) U.S. Cl. CPC B64D 11/00; B64D 2011/0046; B64D 11/02; B64D 11/04

(57) ABSTRACT

A construction group of an aircraft for feeding a line to a connector section of the cabin module includes a flex zone for providing of at least one cabin module having a connector section for physical connection to a line of the aircraft. The flex zone is configured to receive different cabin modules and/or a cabin module at different positions. The construction group further includes a guide element for guiding the line to be connected to the connector section along the fuselage of the aircraft, and a support element extending along the flex zone for feeding the line from the guide element to the connector section, wherein during the receiving of the construction group in the aircraft, the longitudinal axis of the support element includes a component in direction of the attitudinal axis of the aircraft.

### FIELD OF THE INVENTION

The present invention relates to a construction group for an aircraft. Particularly, the present invention relates to a construction group for a cabin of a civilian airplane. The construction group is adapted to feed a line to a connector section of a cabin module. The cabin module may be a galley, a cabinet, and/or another cabin module. The construction comprises a flex zone for providing at least one cabin module which comprises a connector section for a physical connection to a line of the aircraft. The flex zone is adapted to receive different cabin modules and/or a cabin module at different positions. Furthermore, the construction group comprises a guide element for guiding the line to be connected to the connector section of the cabin module along the fuselage of the aircraft, and a support element for feeding the line from the guide elements to the connector section.

### BACKGROUND OF THE INVENTION

Today's civilian airplane cabins comprise so-called flex zones which are designable according to the client's wishes. In those flex zones, e.g. galleys, toilets, cabinets and/or other cabin modules may be provided. Within certain limits, it is a subject of the client to determine the type, the manufacturer as well as the position of the modules within the flex zones.

Approximately all cabin modules of such a flex zone require a physical coupling to a supply system of the airplane. In a galley, for example an interface for the energy supply, an interface for the cooling, an interface for an LCD monitor, an interface for the illumination of the galley, as well as further interfaces may be provided in a connector section of the galley. For the connection of the galley, all those interfaces of the connector section have to be connected to the respective lines of the supply systems of the aircraft.

The position of the connector section of the cabin module depends on the cabin layout of the flex zone which is determined by the client. On the one hand, the position of the module inside the flex zone influences the position of the connector section, wherein on the other hand the position of the connector section also depends on the chosen manufacturer of the cabin module and its functional configuration. In other words, the connector sections of a certain cabin module type of different manufacturers may be arranged on different positions at the module and may further depend in detail on the functional configuration of the module.

The feeding of the supply lines of the aircraft to the connector section of a cabin module inside a flex zone therefore has to be adapted to the cabin layout being chosen by the client. Nowadays, crossbeams are provided for that adaption which extend orthogonally to the longitudinal axis of the aircraft and above the cabin module. Each of those crossbeams serves as feeding for one or several lines to a connector of the cabin module. Particularly, each of those crossbeams guides one or several lines extending along the fuselage on the primary or secondary structure to the respective connector on the cabin module. According to installation rules for e.g. preventing mutual influence of signals in different lines, predominantly more than one crossbeam is required.

The positions of the crossbeams in direction of the longitudinal axis of the airplane are adapted to the cabin layout being chosen by the client. In other words, the crossbeams have to be provided at other positions if the cabin layout of the flex zone changes. To allow the connection of a cabin module for every cabin layout, the connecting lines at the fuselage are provided with such a length which allow the connection at maximum conditions. In all further cases, the lines are correspondingly coiled or trimmed to a suitable length during the installation, particularly if the lines have high current loads which would require disproportionately much space due to the big cross-sections of the cables.

Those construction groups for feeding a line to a cabin module being known from the prior art comprise a high adaption effort to different cabin layouts in the flex zones of the cabin and therefore result in proportionally high costs.

### BRIEF SUMMARY OF THE INVENTION

An aspect of the present invention may provide a construction group for an aircraft for feeding in line to a cabin module, the construction group comprising a low installation effort to different cabin layouts.

The invention is based on an idea that the relatively high adaption effort of the construction groups in the prior art results from the need of providing the crossbeam for feeding the lines from a fuselage of an aircraft to a cabin module in dependence of the cabin layout on different positions. If the position of the crossbeam is shifted, the feeding of the line from the fuselage to the crossbeam and the line itself have to be adapted to the new position of the crossbeam. This condition for the adaption has the consequence that lines having a great length have to be provided, wherein the sections of a line which are not used are coiled.

As a result, the shifting of the crossbeams which is required for different cabin layouts is therefore the reason for the high adaption effort of a construction group.

The present invention uses this finding and provides a construction group for an aircraft, particularly for a cabin of a civilian airplane, for feeding a line to a connector section of a cabin module. The cabin module may be a galley, a toilet, a cabinet and/or a further module. A connector section of the cabin module according to the invention is understood to be a region on the module at which at least one connector for connecting the module to a line of the aircraft is provided. A connector section according to the invention may also comprise several connectors for connecting to different lines of an aircraft. The line may be a cable, a tube, a hose, or another type of line.

The construction group comprises a flex zone for providing at least one cabin module. The cabin module comprises a connector section for physical, i.e. line-bound, connection to a line of the aircraft. The flex zone is configured to receive different cabin modules and/or a cabin module at different positions. As a result, the position of the connector section of the cabin module in the flex zone is independent from the cabin layout of the flex zone being chosen by the client. It is preferred that at least one cabin module in the flex zone is installed at different positions along the longitudinal axis of the aircraft according to the client's wishes. The flex zone may be a part of the airplane cabin. Particularly the flex zone may be provided at a section of the cabin where the cabin preferably does not comprise seats.

Furthermore, the construction group comprises a guide element for guiding the line to be connected to the connector element of the cabin module along the fuselage of the aircraft. The guiding of the line along the fuselage is to be understood according to the invention that the line is arranged in a region close to the fuselage, the region being provided to guide different lines through the airplane. The guide element may for example guide the line through the so-called crown. Particularly, the guide element is mechanically connected to the primary and/or secondary structure of the aircraft. Thereby, according to the invention, the guide element may be arranged closer to the fuselage of the airplane than the connector section of the cabin module.

Furthermore, the construction group comprises a support element for feeding the line from the guide element to the connector section of the cabin module. The support element is particularly configured to lead the line away from the guide element and the fuselage of the airplane to the connector section of the cabin module. The support element therefore serves to lead the line away from the guide element in the proximity of the fuselage to lead the line closer to the connector section of the cabin module. In other words, the support element therefore functions as a link for guiding the line between the connector section of the cabin module and the guide element. According to an embodiment of the invention, the support element is arranged such that its longitudinal axis comprises a component in direction of the longitudinal axis of the aircraft, when the construction group is received by the aircraft. According to an embodiment of the invention, a longitudinal axis of an element runs in the direction of the main extension of the element. According to an embodiment of the invention, the longitudinal axis of a support element therefore has to at least extend along the direction of the longitudinal axis of the aircraft when the construction group is received by the aircraft. According to an embodiment of the invention, the longitudinal axis may further orthogonally extend to the longitudinal axis of the aircraft.

The present invention leads to the advantage that different cabin layouts of the flex zone which lead to different positions of the connector sections of the cabin modules do not require a shifting of the crossbeams for feeding the lines. Instead, the support element comprising an extension in longitudinal direction of the aircraft allows that the lines may be fed to the connector sections at different positions via a single, fixed support element. The inventive configuration further allows, that the feeding of the lines from the guide elements in the proximity of the fuselage to the support element may be identically adapted for all cabin layouts of the flex zone, such that for different cabin layouts, only the feeding from the connector section of the cabin module to the support element has to be adapted. This minimizes the adaption effort of the construction group to different cabin layouts of the flex zone and therefore minimizes the costs.

In a preferred embodiment, the longitudinal axis of the support element is parallel, in a top view particularly congruent, to the longitudinal axis of the aircraft during the receiving of the construction group in the aircraft. This allows to span a big region of the flex zone in longitudinal direction of the aircraft with the support element. Furthermore, this configuration leads to a compact construction type allowing a simpler integration of the construction group in the cabin of an aircraft. The provision of the support element along the longitudinal axis of the aircraft further simplifies the integration since the fuselage provides most of the space in the center.

The construction group may be configured such that the support element is arranged above the flex zone during the receiving of the construction group in the aircraft. Particularly, the construction group may be configured to provide the support element above the cabin module being arranged in the flex zone. Preferably, the support element extends above the cabin module being arranged in the flex zone. According to an embodiment, also the guide element is provided above for the flex zone during receiving the construction group in the aircraft. The guide element may also extend above the cabin module which is received in the flex zone. Particularly, the guide element and the support element may be arranged in parallel to each other. The guide element is mechanically connected to the primary and/or secondary structure of the aircraft.

According to a preferred embodiment, the construction group comprises several particularly two or three support elements. The support elements are arranged one after another. This configuration leads to the advantage that the construction group allows a feeding of a line 4 all possible cabin layouts of the flex zone of a common twin aisle airplane with low adaption effort of the construction group. The provision of several support elements further allows a relatively light and cheap configuration of the single support elements which are configured to have relatively small sizes due to their relatively small length. That embodiment therefore provides a good compromise between weight and variability.

Preferably, the support element comprises a support profile and fixation devices which are provided at the end of the support profile for fixing the support element in the cabin of an aircraft. Particularly, the support profile may be configured to be C-shaped. The fixation devices may be configured to be X-shaped. Of course, also further shapes for the support profile may be provided. That configuration results in the light and cheap support element having a high stiffness.

According to a preferred embodiment, the support element comprises at least one line holder for guiding the line, which has to be fed to the connector section of the cabin module in the flex zone, along the longitudinal axis of the support element. The line holder may be a cable guide or a cable clamp. Hereby, also further holders are possible. The line holder can be configured to hold a bundle of cables comprising several cables, wherein the bundle of cables comprises a protection hose. Preferably, the support element comprises several of such line holders for guiding several lines along the support element, wherein the lines may be provided on opposite sides of the support element. Those several line holders may be arranged on top of each other during the receiving of the construction group in an aircraft. According to a particularly preferred embodiment, on one side, the support element comprises four cable holders being arranged on top of each other, each for guiding one bundle of cables, and on the opposite side of the support element, the support element comprises three cable orders being arranged on top of each other, each for guiding one bundle of cables. This preferred embodiment allows to guide a plurality of lines above the support element resulting in a compact construction type and a particularly low adaption effort to different cabin layouts of the flex zone.

The construction group preferably comprises a line, particularly a cable, which may be connected to the connector section of the cabin module. That line extends from the guide element to the support element. The construction group is therefore configured to identically carry out the feeding of the line from the guide element to the support element for different positions at the connector section inside the flex zone. In other words, the feeding of the line from the guide element guiding the line along the fuselage to the support element guiding the line from the guide element away from the fuselage to the connector section does not have to be adapted to a changing layout of the flex zone. The only adaption of the line feeding due to a changing layout of the flex zone is therefore only required in the feeding from the connector section to the support element. As a result, the necessary adaption of the construction group to changing layouts of the flex zone is further reduced.

Preferably, the construction group comprises a cabin module being arranged in the flex zone and comprising a connector section for connecting to the line of the aircraft, the connector section being preferably provided on the top of the module. The connector section is arranged further away from the fuselage than the guide element during the receiving the construction group, wherein the support element guides the line from the guide element in the proximity of the fuselage to the connector section of the cabin module.

Particularly, the cabin module and the support module may be arranged to each other such that the connector section is provided directly below the support element. This further reduces the adaption effort since the distance between the cabin module and the support element is minimized.

The cabin module may be a galley, a toilet, a cabinet, or a further cabin module. Also, further cabin modules are possible.

Furthermore, the present invention relates to an aircraft, in particular to a civilian airplane, with a cabin and a construction group according to the previously described embodiments. The flex zone of the construction group may be located in the region of the cabin, particularly in the region of the door of the aircraft. Also, further arranging regions are possible. Concerning the advantages of the aircraft, it is referred to the previously described advantages of the construction group for an aircraft.

The present invention further relates to a method for connecting a connector section of the cabin module in an aircraft to a line of an aircraft. The cabin module is arranged in a flex zone which may receive different cabin modules and/or a cabin module at different positions. The aircraft may preferably be an aircraft according to the embodiments described above. The method comprises the adaption of the guiding of the line to a support element to the position of the position of a connector section of the cabin module in the flex zone. The support element guides the line from the guide element which guides the line along with the fuselage of the aircraft, to the connector section, wherein the longitudinal axis of the support element comprises a component in direction of the longitudinal axis of the airplane. Furthermore, the method comprises the connection of the line on the support element to the connector section of the cabin module. Preferably, the method comprises only those steps. Concerning the advantages of the method, it is referred to the previously described advantages regarding the construction group for an aircraft.

### BRIEF DESCRIPTION OF THE DRAWINGS

FIG. 1 shows a perspective from view of a construction group for feeding a line to a cabin module of an aircraft according to an embodiment of the present invention.

FIG. 2 shows a perspective back view of the construction group of FIG. 1.

FIG. 3 shows a cross-section of a support element of a construction group for feeding a line to a cabin module of an aircraft according to an embodiment of the present invention.

FIG. 4 shows a schematic top view of a flex zone of the cabin of an aircraft which shows a possible cabin layout of the flex zone, wherein the cabin comprises a construction group for feeding a line to a cabin module according to an embodiment of the present invention.

### DETAILED DESCRIPTION

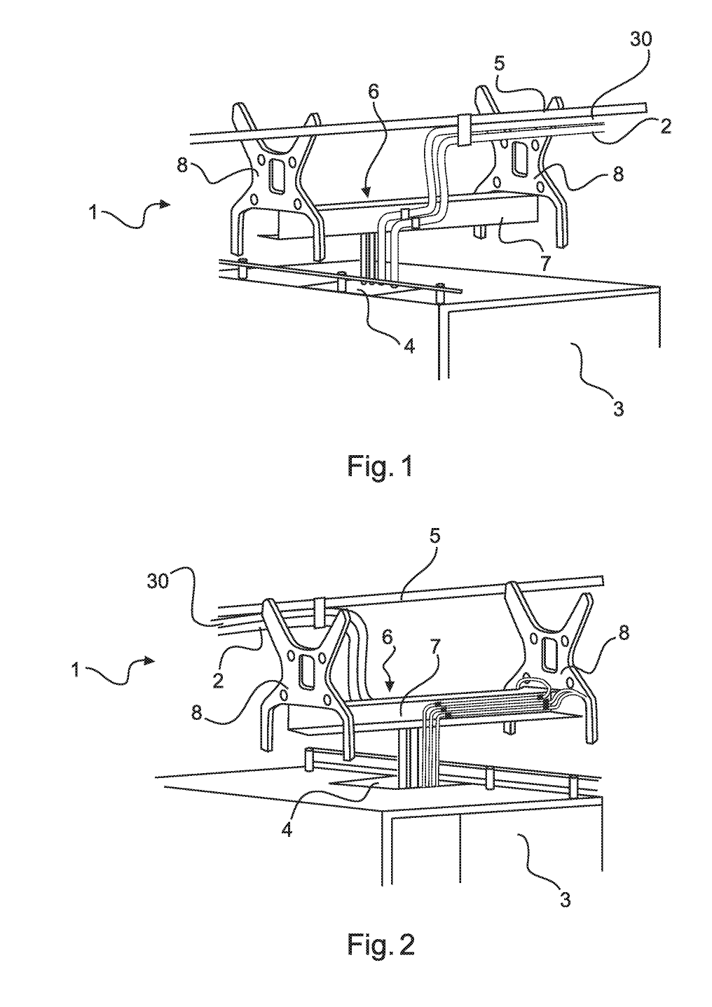

FIGS. 1 and 2 show a construction group 1 for feeding a line 2 of an aircraft to a connector section 4 of a cabin module 3 according to an embodiment of the present invention. In line with the present embodiment, the aircraft preferably is a civilian airplane, wherein the embodiment is not limited to that.

The construction group 1 comprises a guide element 5 which is arranged such that during the receiving of the construction group 1 in the airplane the line 2 leads to the fuselage of the airplane. Preferably, the guide element 5 guides the line 2 along the top section of the fuselage. Particularly, the construction group 1 is configured to provide the guide element 5 in the crown of the cabin of an aircraft. Preferably, the guide element is mechanically connected to the primary and/or secondary structure of the aircraft. In this embodiment, the guide element 5 may preferably be an elongate support which extends along the cabin ceiling through the complete cabin. Several cables 2, 30 may be guided along the guide element 5 through the airplane cabin. In line with the present embodiment, also several of such guide elements each for guiding of one or more cables through the cabin of the aircraft may be provided.

Furthermore, according to this embodiment, the construction group 1 comprises a support element 6. The support element 6 is arranged to and configured to allow the support element to feed the line 2 from the guide element to the connector section 4 of the cabin module 3. Since the connector section 4 is provided further away from the fuselage than the guide element 5, the support element 6 functions as link between those components. The support element 6 of those preferred embodiment is further arranged to allow its longitudinal axis I to run parallel to the longitudinal axis L of the airplane cabin 20 during receiving the construction group 1 in an airplane cabin 20, as shown in FIG. 4. In that preferred embodiment, the support element 6 is further arranged to be positioned in the middle of the cabin in direction of the width of the cabin during the receiving of the construction group one in the airplane cabin 20, as shown in FIG. 4.

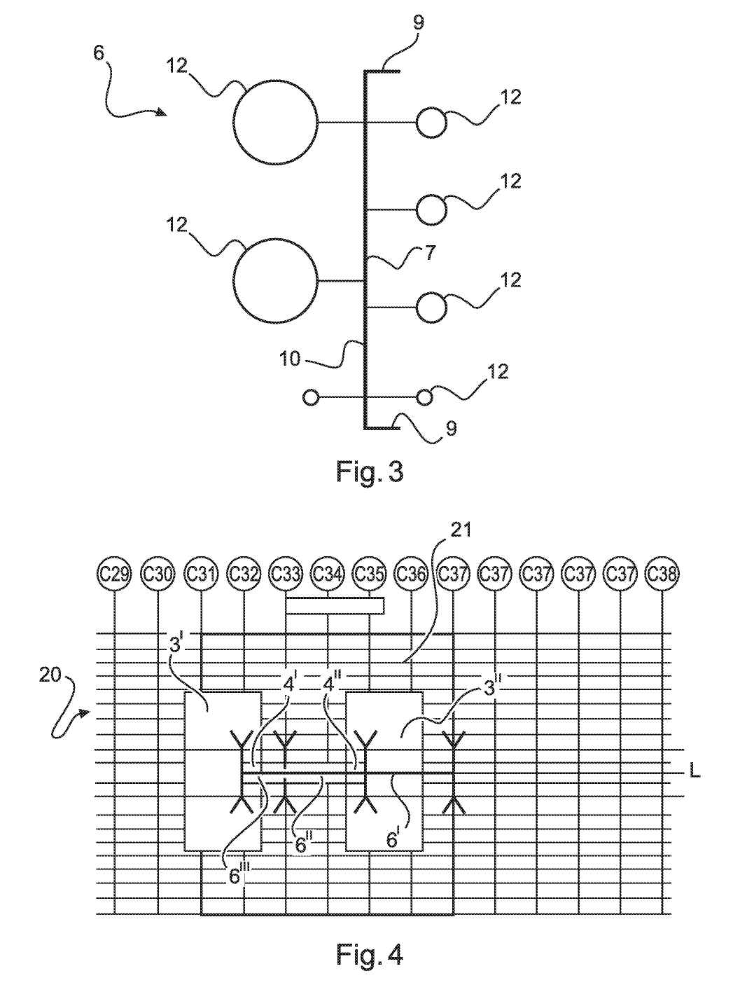

As shown in FIG. 3, which shows a cross-section through a support element 6 according to an embodiment of the present invention, the support profile 7 of the support element 6 may be configured to be C-shaped. In its cross-section, the profile 7 therefore comprises particularly two legs 9 of equal length being provided orthogonally on the ends of a connection member 10. Also, further profile shapes are possible. In line with the present embodiment, line holders 12 are provided in the form of cable holders on the connection member 10 of the support profile 7 of the support element 6. The cable holders may be configured to guide cables having different diameters along the support element 6. Particularly, at least some of the cable holders of the present embodiment are configured to hold a bundle of cables, wherein the bundle of cables may preferably comprise a protection hose. In line with the embodiment, several cable holders 12 may be provided on each side of the connection member 10 of the support profile 7 of the support element 6, e.g. three on the one side and four on the opposite side of the connection member 10. The support element 6 of the present embodiment may therefore be configured to feed several different cables from one or several guide elements 5 to the connector section 4 of the cabin module 3, each guiding element guiding the cables along the fuselage of the airplane. In FIGS. 1 and 2, only one guide elements 5 is shown. A further or several further guide elements for feeding a line to the support element 6 may be attached to the primary and/or secondary structure of the aircraft in line with the present invention. E.g., during the receiving of the construction group 1 in an aircraft, a further guide element for feeding a line to the support element 6 may be provided on the level of the support element 6, wherein the present invention is not limited to that. Particularly, cables may be fed to the connector section 4 from different directions on the support element 6. Those cables, which are fed to the connector section 4 from different directions, are preferably arranged on opposite sides of the support element 6.

The present embodiment of the construction group 1 for feeding a line to a connector section 4 further comprises a cabin module 3. The cabin module 3 of this preferred embodiment may particularly be a galley. The galley 3 comprises a connector section 4 which is provided on the top of the galley. The construction group 1 may be configured to be such that the support element 6 extends above the galley 3 such that the connector section 4 is arranged directly below the support element 6. Thus, in that preferred embodiment, the construction group 1 allows that the lines 2, 30 extend from the guide element 5 to the support element 6 and along the support profile 7 of the support element 6 in direction of the longitudinal axis of the airplane to above the connector section 4, wherein those lines 2, 30 may be connected to the connector section 4 which is provided on the top side of the galley 3.

Concerning its position on the module as well as the arrangement of different cables or bundle of cables, respectively, the connector section 4 may be harmonized over different module types. This allows, that an adaption of the construction group 1 to different module types in the flex zone is not required. The construction group 1 just has to be configured to be such that it allows the installation of all possible combinations of cables or bundles of cables, respectively, for different module types.

The construction group 1 of that preferred embodiment further comprises a flex zone 21, which preferably is provided in the cabin 20 of an airplane. Inside the flex zone 21, cabin modules may be arranged on different positions and/or different cabin modules, e.g. cabin modules from different manufacturers. This results in that the connector sections 4 of the cabin modules 3 are arranged in dependence of the chosen cabin layout of the flex zone 21 on different positions. FIG. 4 exemplary shows a possible cabin layout of the flex zone 21. In that cabin layout, a galley 3′ is arranged on the left edge of the flex zone 21, wherein a further galley 3″ is provided on the right edge of the flex zone 21. Accordingly, the connector sections 4′ and 4″ of the galley's 3′ and 3″ are provided on different positions. Of course, in line with the present embodiment, further arrangement positions of the galley 3 in the flex zone 21 are possible.

If the galley 3 is shifted in direction of the longitudinal axis L of the airplane inside the flex zone 21 of that preferred embodiment, only the feeding of the lines from the connector section 4 of the cabin module 3 to the support profile 7 of the support element 6 has to be adapted. In other words, only the position on which the lines of the connector section 4 meet the support profile 7 changes. The position of the support element 6 and the feeding from the guide element 5 to the support element 7 do not have to be changed. The reason is, that the support element 6 extents in direction of the longitudinal axis L of the airplane. Thus, the adaption effort of the construction group 12 different cabin layouts of the flex zone 21 is very low.

To cover a maximum spectrum of cabin layouts in the flex zone 21, the construction group 1 may comprise three support elements 6′, 6″ and 6′″, which are arranged one after another as shown in FIG. 4. Such a construction type assures the low weight of the construction group 1 since the single support elements 6′, 6″ and 6′″ may be dimensioned relatively slim due to their relative short length, wherein at the same time, the total flex zone 21 is spanned by the group of support elements 6′, 6″ and 6′″. This allows a great variety of possible layouts in the flex zone which may be supplied with the lines of the airplane by the construction group of this embodiment without a great adaption effort. Of course, another number of support elements 6 is possible.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A construction group for an aircraft, for feeding a line to a connector section of a cabin module, comprising:
a flex zone for providing of at least one cabin module, that comprises a connector section for physical connection to a line of the aircraft, wherein the flex element is configured to receive different cabin modules and/or a cabin module on different positions;
a guide element for guiding the line to be connected to the connector section along the fuselage the aircraft; and
a support element extending along the flex zone for feeding of the line from the guide element to the connector section, wherein during the receiving of the construction group in the aircraft, the longitudinal axis of the support element comprises a component in direction of the longitudinal axis of the aircraft.

2. The construction group according to claim 1, wherein the longitudinal axis of the support element is arranged parallelly to the longitudinal axis of the aircraft, during the receiving of the construction group in the aircraft.

3. The construction group according to claim 1, wherein the support element and the guide element are provided above the flex zone during the receiving of the construction group) in the aircraft.

4. The construction group according to claim 3, wherein the guide element is mechanically connectable to the secondary structure and/or the primary structure of the aircraft.

5. The construction group according to claim 1, comprising several support elements being arranged one after another.

6. The construction group according to claim 1, wherein the support element comprises a support profile being configured to be C-shaped, and fixation devices which each are provided at the end of the support profile for fixing the support element in the cabin of an aircraft.

7. The construction group according to claim 1, wherein the support element comprises at least one cable holder for leading the line along the longitudinal axis of the support element.

8. The construction group according to claim 1, wherein the support element comprises a plurality of cable holders for leading the line along the longitudinal axis at opposite sides.

9. The construction group according to claim 1, further comprising a line for connecting to the connector section of the cabin module, the line extending from the guide element to the support element,
wherein the construction group is configured to be such, that the feeding of the line from the guide elements to the support element is configured to be identical for different positions of the connector section inside the flex zone and only the feeding from the connector section to the support element has to be adapted to the different positions of the connector sections in the flex load.

10. The construction group according to claim 1, further comprising a cabin module being provided in the flex zone, the cabin module comprising a connector section for connecting to the line of the aircraft, the connector section being arranged on the top side of the module, wherein during the receiving of the construction group in an aircraft, the connector section is arranged further away from the fuselage of the aircraft then the guide element.

11. The construction group according to claim 10, wherein the cabin module and the support element are arranged to each other such that the connector section is provided directly below the support element.

12. The construction group according to claim 10, wherein the cabin module comprises a galley, a toilet and/or a cabinet.

13. The construction group according to claim 1, wherein the support element is configured to feed all lines being required for the proper operation to every possible cabin module type in the flex zone, without requiring structural adaptions of the support element.

14. An aircraft with a cabin and a construction group according to claim 1, wherein the flex zone is provided in a door region.

15. A method for connecting a connector section of a cabin module of an aircraft to a line of an aircraft, the cabin module being arranged in the flex zone being able to receive different cabin modules and/or a cabin module at different positions, wherein the aircraft is an aircraft according to claim 14, the method comprising:
adapting the guiding of the line on a support element to the position of the connector section in the flex zone, wherein the support element feed so the line from a guide element which guides the line in the proximity of the fuselage to the connector section, and wherein the longitudinal axis of the support element comprises a component in direction of the longitudinal axis of the aircraft; and
connecting the line on the support element to the connector section of the cabin module.
